(19) United States
(12) Patent Application Publication
(10) Pub. No.: US 2026/0085821 A1
(43) Pub. Date: Mar. 26, 2026

(54) SECURITY PROFILE STRIP FOR A DOOR OR WINDOW OF A TRANSPORTATION SYSTEM

(71) Applicant: HÜBNER GmbH & Co. KG, Kassel (DE)

(72) Inventors: Lars KRUG, Immenhausen (DE); Martin BREUNINGER, Neu-Ulm (DE)

(73) Assignee: HÜBNER GmbH & Co. KG, Kassel (DE)

(21) Appl. No.: 19/334,323

(22) Filed: Sep. 19, 2025

(30) Foreign Application Priority Data
Sep. 20, 2024 (EP) 24201640.0

(51) Int. Cl. F21V 19/00; F21V 23/04; F21W 111/00; F21Y 115/10

(52) U.S. Cl. CPC F21V 19/0015; F21V 23/0471; F21W 2111/00; F21Y 2115/10

(57) ABSTRACT

A security profile strip for a door or a window of a transportation system, a train or bus platform, or for a gate or a barrier. The security profile strip has a base body that includes at least one connecting portion. The security profile strip has at least one light-emitting device. The security profile strip has a cover which is at least partially translucent and separate from the base body and which comprises at least one mating connecting portion. The connecting portion and the mating connecting portion are connected to one another. At least one surface of the base body and the cover define a first hollow chamber in which the light-emitting device is accommodated when viewed in cross section transverse to the longitudinal direction of the security profile strip.

### CROSS-REFERENCE TO RELATED APPLICATIONS

This application claims priority to European Patent Application No. 24201640.0 filed Sep. 20, 2024. The disclosure of the above-identified application, including the specification, drawings, and claims, is incorporated by reference herein in its entirety.

### TECHNICAL FIELD

The present disclosure relates to a security profile strip for a door or a window of a transportation system such as a train or bus platform, or for a gate or a barrier. It also relates to a window or door element with a security profile strip and a rail or road vehicle or a train or bus platform with such a window or door element. Furthermore, the present disclosure relates to a method of manufacturing a security profile strip. In particular, the present disclosure relates to a security rubber profile strip that has a predetermined flexibility or elasticity.

Security profile strips, for example made of rubber or an elastomer, are traditionally used in vehicles, for example, to provide a seal between a door and a frame or another door. Therefore, the security profile strips are attached to the edges of aluminum or steel door profiles.

### BACKGROUND

Due to the increased demands on transportation systems and increased safety regulations, security profile strips can also have one or more signaling functions in addition to their sealing function due to their elasticity. For example, contact elements are integrated into many security profile strips, which indicate contact with an object or a user and interrupt or stop the movement of the door or moving element if necessary. In addition, security profile strips are known that have a light grid arrangement, with which a space around the moving door is monitored without contact by emitting and receiving a non-visible light. Based on changes in the light received, it is possible to identify an object or a person within the movement range of the door, and control it accordingly.

It is known from document RU 2 789 015 C1 to integrate signal lamps into aluminum or steel door profiles in a transportation system.

It is known from the documents FR 3 051 732 A1 or EP 3 894 744 A1 to insert an insert strip with a light source held therein into a receptacle of a profile strip. This additional insert strip itself is translucent, so that the light source can shine through the translucent profile.

### SUMMARY

The object of the present disclosure is to provide a security profile strip with a signaling function that can be easily retrofitted and/or replaced, wherein sufficient protection against environmental influences and/or vandalism is nevertheless to be guaranteed.

The object is achieved by the features of the claims.

The present disclosure is based on the realization that the light-emitting devices of the security profile strips known from the prior art are difficult to access due to their attachment to the door profile or embedding in an insert strip, and their installation and replacement are correspondingly complex. To achieve the object, it is therefore proposed to provide a hollow chamber for a light-emitting device on the security profile strip, in which it is securely accommodated, but which can also be easily opened and reclosed, for example to replace the light-emitting device.

A security profile strip according to the present disclosure can be attached to a door or a window of a transportation system to protect against reaching in and becoming trapped. Transportation systems within the meaning of the present disclosure are in particular commercial vehicles, elevators, aircraft, or cable car gondolas. The security profile strip according to the present disclosure is used on doors or other movable elements of a transportation system in order to protect persons using the transportation system from becoming trapped in this movable element, and at the same time to signal a movement or generally a state of the door or the movable element. A similar anti-trap protection can be realized when the security profile strip according to the present disclosure is used on a door or a window of a train or bus platform, so that passengers waiting there can also be protected from potential injuries caused by a sudden closing of the door, for example in the event of a malfunction of a platform door.

The security profile strip comprises a base body. This usually has an elongated shape and can have a considerable variety of shapes in cross section. The base body can, for example, have a rectangular or almost rectangular, round or almost round, triangular, quadrilateral, pentagonal, or polygonal shape, or a mixture of these. For example, its outer faces can include a rounded or oval face and one or more straight faces. In embodiments, the base body can be attached to an edge of a movable element, such as a door.

According to the present disclosure, the base body has a connecting portion. This can be used to connect to a mating connecting portion. The connecting portion may be an edge part of the base body and have the same configuration as the rest of the body or certain other parts of the base body. It can differ in its properties, for example, in material, roughness, density, color, hardness, strength, elasticity, electrical or thermal conductivity, but also from adjacent parts of the base body that cannot be assigned to the connecting portion.

The security profile strip also has a light-emitting device. This can be a single light source, several light sources, and/or a light-guiding element.

In addition, the security profile strip has an at least partially or possibly completely translucent cover that is separate from the base body. At this point, separate means that the cover is a separate and independently existing from the base body component, which has a fundamentally different composition, appearance, or material compared to the base body. In the event of maintenance, the cover can be removed from the base body with little effort. The cover can be made of a plastic, for example an elastomer such as ethylene-propylene-diene rubber, chlorosulfonated polyethylene, polyvinyl chloride, high-density polyethylene, nitrile rubber or butyl rubber, or a mixture of these. However, the cover is not limited to a specific material and may also be made of a translucent thermoplastic such as polystyrene, acrylic glass, or polycarbonate. The cover can take the form of a film or a membrane, or be configured in the same way as a film or a membrane. In this context, it can have a thin, flat structure. The film could be made of flexible plastic, for example. The design of the cover can help to prevent vandalism, as components behind it are not visible and/or at least not directly accessible to those looking at the cover from the outside.

According to the present disclosure, the cover has a mating connecting portion. Analogous to the connecting portion, this can be an edge part of the cover or also be congruent with the entire cover and have the same configuration as the remaining part or certain other parts of the cover. It can differ in its properties, for example, in material, roughness, density, color, hardness, strength, elasticity, electrical or thermal conductivity, but also from adjacent parts of the cover that cannot be assigned to the mating connecting portion.

The direction of the longitudinal extension of the base body of the security profile strip can be referred to as the x-direction, and the directions of the base body at 90 degrees to it can be referred to as the y- and z-directions (width and height).

According to the present disclosure, the mating connecting portion and the connecting portion are connected or connectable to one another. The mating connecting portion of the cover is connected to the connecting portion of the base body, so that the open recess at the edge of the base body becomes a closed hollow chamber (at least in cross section transverse to the longitudinal direction, i.e. viewed in the y-z plane). The connection of the base body and cover components results in a new component. This new composite component is expressly made from two originally separate components, namely the base body and the cover, i.e. it is not manufactured in one piece. The hollow chamber can be defined not only by the surface of the base body and the cover, but also by additional components.

By accommodating the light-emitting device in the hollow chamber on the security profile, the rigidity of door profiles is not affected—unlike in solutions known from the prior art such as the integration of signal elements. Furthermore, the light-emitting device can be easily mounted, as it is inserted, for example retracted, in the longitudinal direction into the hollow chamber created by the connecting portion and the mating connecting portion. As long as the hollow chamber is not, or not completely, closed in one of the three orientations, steps such as inserting, aligning, fastening, or electrically contacting the light-emitting device can be carried out easily.

In addition, with a profile emitting light on one or both sides, a differentiation can be made between the light emitted from the interior space and the exterior of a vehicle, for example.

As an alternative to use on a door or window of a transportation system, it can also be used on a roller door or in a parking barrier. This list of possible applications for the security profile strip is an example and is not an exhaustive list. For ease of reading, the following refers to a security profile strip on a door of a transportation system, such as a rail or road vehicle.

In one embodiment of the present disclosure, the connection between the connecting portion and the mating connecting portion is materially bonded and/or form-fitting.

In a materially bonded connection, the materials of the two portions are joined together in such a manner that they form a fixed and/or structural unit. The materially bonded connection between the two portions is characterized by the bonding between the molecules in the material. This can be achieved by gluing, vulcanization, or other methods. The two portions form a strong connection here; this has a homogeneous structure with high strength, is resistant to high temperatures, chemical influences, and other environmental influences, and is therefore resistant to aging and durable. By selecting specific vulcanization techniques and process parameters such as the surface and translucency of the portions or the cover, the properties of the end product can be specifically adapted. If the light needs to be refracted more for a certain visual appearance, for example, in order to block out individual spots, then the function of the cover must also be that of a diffuser. This means that various additives or fillers, such as scattering particles, are already taken into account when selecting the material for the cover. The diffusion of the light ensures uniform illumination.

Form-fitting connections are connections in which forces and moments are transferred by the interlocking of components. This means that the shape of the connecting elements is designed in such a manner that they block one another and thus prevent movement. Form-fitting connections are secure because they remain in place even if other forces (such as friction) fail. They are less susceptible to loosening due to vibrations or other external influences. The form-fitting connection between the connecting portion and the mating connecting portion is easy to assemble and disassemble. This simplifies maintenance and repair work and enables efficient handling. The connecting and mating connecting portions can be positioned precisely in relation to one another. The direct interlocking means that no additional pre-tensioning or internal stress is required, as is the case with a friction-locked connection.

The form-fitting connection can be realized by a clamping connection, for example by clamping the cover between protruding sections, or also by a snapping connection or a latching connection, in which the mating connecting portion has special latching lugs that latch into corresponding recesses in the connecting portion; an inverted arrangement is also possible. In all form-fitting connections, both the connecting portion and the mating connecting portion can be the “male”, just like the “female” connection partner, i.e., a pin and a socket, for example.

In one embodiment of the present disclosure, at least one edge recess is formed in the base body, in which the light-emitting device is arranged. The mating connecting portion of the cover is connected to the connecting portion of the base body so that the open recess on the edge of the base body becomes a closed hollow chamber. This recess can serve as a kind of light channel that guides the light from the light source to the surface of the security profile strip. The light channel is created, for example, by blocking the passage of light through the opaque base body and/or by deflecting the light towards the translucent exit area using reflectors on the inner walls. The recess is also suitable for holding and attaching the light-emitting device. The light-emitting device can be protected as well as possible from external influences in the hollow chamber.

According to one possible embodiment, the base body for receiving the light-emitting device does not have a recess, but a flat or at least substantially flat surface. Here, the cover has a curvature instead, which creates a hollow chamber when the connecting portion is connected to the mating connecting portion. This has the aspect that different base bodies do not have to be provided for different light-emitting devices, but the variety of hollow chambers for the light-emitting device can be ensured by the differently curved covers.

According to one possible embodiment, the security profile strip has a plurality of edge recesses, for example three or four, whereby light can be emitted from several hollow chambers or from a hollow chamber connecting several edge recesses. These recesses are arranged parallel to and at a distance from one another in the longitudinal direction of the base body. This adds additional signaling options.

In a particular embodiment of the present disclosure, the cover and/or the base body is made of a wholly or partially elastic material. Due to the elastic materials, the security profile strip can be adapted to different surfaces and shapes. If the security profile strip is made of such a material, it can act as a buffer and protect sensitive areas from damage in the event of impacts, vibrations, or other mechanical loads. Elastic materials are often easier to handle and to install. This is particularly important if the security profile strip needs to be retrofitted or replaced. A relevant property of elastic materials is their sealing effect. Elastic materials such as the synthetic rubbers (nitrile rubber and butyl rubber, EPDM, and silicone) are also resistant to moisture, UV radiation, and other environmental influences. The materials may also contain fire-retardant or UV-stabilizing additives.

In one embodiment of the present disclosure, an opaque material is used for the base body and/or the cover of the security profile strip. Opaque materials are impervious to light and therefore help to better channel the light emitted by the light-emitting device. In the prior art, there are many solutions in which the light-emitting device is surrounded exclusively by translucent material, which does not limit the light emission and thus, for example, does not allow any differentiation between signals on the inside and outside of a vehicle. Delimiting one part of the hollow chamber between the base body and the cover with a translucent material and another part with an opaque material is therefore desirable for many applications. If the security profile strip is used as a signaling device or warning light, an opaque material can help reduce glare. It prevents the light from shining too brightly into the surroundings and impairing visibility. Opaque materials can help to conceal unsightly components. If the security profile strip is used in public places or interior spaces, an opaque material can help to ensure a clean and unobtrusive appearance. Opaque materials such as rubber in general, or other plastics such as polyethylene or polyvinyl chloride, also offer a certain degree of protection against UV radiation. This can extend the service life of the security profile strip, especially outdoors.

Further variants of the present disclosure describe security profile strips with arbitrarily complex structures around the hollow chamber with the light-emitting device. For example, a plurality of opaque and translucent portions may also exist across the circumference of the hollow chamber, wherein opaque and translucent portions may be part of the cover as well as part of the base body. The arrangement and thus targeted blocking and guidance of the light can be used to cover certain areas of the hollow chamber or to block the light in a targeted manner.

The sealing properties inherent to any elastic security profile strip make it easier to integrate other elements with different functions into the profile strip, as the transportation system in particular are used in a humid environment with large temperature fluctuations and mechanical stresses, which requires sufficient sealing, especially of electrical components. This is particularly important for the durability of the security devices.

The integration of further hollow chambers into the security profile strip opens up additional possibilities and functions. In one embodiment of the present disclosure, a second hollow chamber is provided for a pressure detection apparatus or an electrical contactor. If the security profile strip contains a pressure detection apparatus, it can be used to capture or monitor certain information. For example, the pressure detection apparatus can measure pressure on the security profile strip, which can indicate unusual loads or vandalism. An electrical contactor can act as a switch or a sensor. If the security profile strip is equipped with such a contactor, it can react to certain events. For example, the contactor can be activated by touch. The second hollow chamber can be used in many ways. It can be used to integrate security systems, lighting controls, or various sensors. Depending on the requirements, various components can be installed in this hollow chamber. A pressure detection apparatus and/or an electrical contactor can also be used together with the light-emitting device in the first hollow chamber or otherwise accommodated in the area of the base body. However, a separate hollow chamber for a pressure detection apparatus or an electrical contactor can also have certain aspects, for example if only the light-emitting device or only the pressure detection apparatus needs to be replaced or repaired, and access to the light-emitting device or the pressure detection apparatus is easier with a separate hollow chamber.

In one embodiment of the present disclosure, a further hollow chamber, hereinafter simply referred to as the third hollow chamber, is provided in the security profile strip. This can also be used if no second hollow chamber is provided. Ultrasonic transmitters and/or detectors can be arranged in this hollow chamber, wherein these elements can of course also be arranged in the first or second hollow chamber, together with other components or otherwise accommodated in the area of the base body. Ultrasonic sensor technology works without contact, is insensitive to dust or contamination, and can detect obstacles between doors or windows very sensitively and efficiently. In an automatic door system, the ultrasonic transmitter can measure the distance to the obstacle (e.g., a hand) and control the door accordingly to avoid collisions. These security related functions can be combined with the signaling functions of the security profile strip.

The hollow chambers can have a wide variety of cross sections, for example a round or oval, a rectangular, a square, a triangular, pentagonal, or hexagonal cross section. All hollow chambers can have the same cross section. However, the hollow chambers can also have at least partially different cross sections. With round hollow chambers, any loads acting on them are distributed evenly over the entire face. Rectangular hollow chambers are stiffer and more dimensionally stable than round hollow chambers. Due to their shape, they fit well with rectangular openings.

In one embodiment, the hollow chambers described may be elongated and/or cylindrical. Elongated hollow chambers distribute the load evenly over their length. The cylindrical shape enables a uniform wall thickness along the hollow chamber.

The hollow chambers can be filled with air and/or coated on their inner walls. If the hollow chambers are filled with air, they provide additional insulation and cushioning. Coatings can protect the hollow chambers from corrosion or reduce friction. In particular, the opaque portions of the connecting portion can be fully or partially coated with a light-colored or reflective material, which results in an increase in light output.

The base body and/or the cover can have at least one further chamber located in the direction of emission of the light-emitting device, which serves to scatter the light emitted by the light-emitting device. Alternatively or additionally, the further chamber can have a certain wall thickness, a suitable filling material, or a special structure to enable dispersion.

A variety of embodiments of the present disclosure can be distinguished in the choice of light-emitting device. For example, but not exhaustively, the security profile strip can be equipped with one or more of the light-emitting devices from the following list: The light-emitting device may comprise a light-emitting diode (LED), an organic light-emitting diode (OLED), a side light fiber, a light guide, a luminescent, electroluminescent and/or a photoluminescent material. The list is not exhaustive, the light-emitting device can also be of another type, not mentioned here.

LEDs have a lower power consumption, which reduces energy consumption. They are also durable, insensitive (e.g., to impacts), available at full brightness as soon as they are switched on, and produce flicker-free light. Side light fibers are designed so that the light guided in the core is not only transmitted along the fiber, but is also emitted laterally. This allows the light to be distributed spatially. Side light fibers reduce the direct light emission from the light source and provide more pleasant lighting. Light guides enable the efficient transmission of light over longer distances. Light guides minimize light losses and offer high signal quality. Luminescent materials emit light after being supplied with energy, e.g., through chemical reactions (chemiluminescence). Luminescent materials have a long service life and are versatile in their application.

The present disclosure also includes the arrangement of a security profile strip according to the present disclosure on a door or window. The security profile strip can be arranged in particular on the main closing edge, but also on any secondary closing edge. The security profile strip prevents fingers or other parts of the body from being trapped, for example, between the door leaf and the door frame. The secondary closing edge provides additional protection, especially when the door leaf is moved sideways. If both edges are equipped with a security profile strip, comprehensive security can be guaranteed. The integration of the light-emitting device enables the possibility of optical signaling and can thus contribute to a further increase in security, for example.

In the present disclosure, the transportation system also includes a rail vehicle such as a mainline train, a tram, or a metro, as well as a road vehicle such as a bus.

In addition, the present disclosure also comprises a method of manufacturing such a security profile strip. This method comprises at least the following steps: providing a base body with a connecting portion, providing an at least partially translucent cover which is separate from the base body and has a mating connecting portion, providing a light-emitting device, and connecting the connecting portion and the mating connecting portion to create a hollow chamber in which the light-emitting device is enclosed, as seen in the longitudinal cross section of the security profile strip. All embodiments mentioned in variants within this application are analogously producible and protected by variants of the co-protected method.

The explanations relating to the security profile strip according to the present disclosure apply accordingly to the embodiments of the method according to the present disclosure, the rail or road vehicle according to the present disclosure, and the window or door according to the present disclosure.

### BRIEF DESCRIPTION OF FIGURES

Further embodiments are shown in the figures.

In the figures:

FIG. 1 is a cross-sectional view of an embodiment of a security profile strip according to the present disclosure;

FIG. 2 is a cross-sectional view of an embodiment of a security profile strip according to the present disclosure with an attached cover,

FIG. 3 is an isometric view of a security profile strip according to the present disclosure,

FIG. 4 is an isometric view of a security profile strip according to the present disclosure,

FIG. 5 is a cross-sectional view of an embodiment of a security profile strip on both sides with an attached cover,

### DETAILED DESCRIPTION

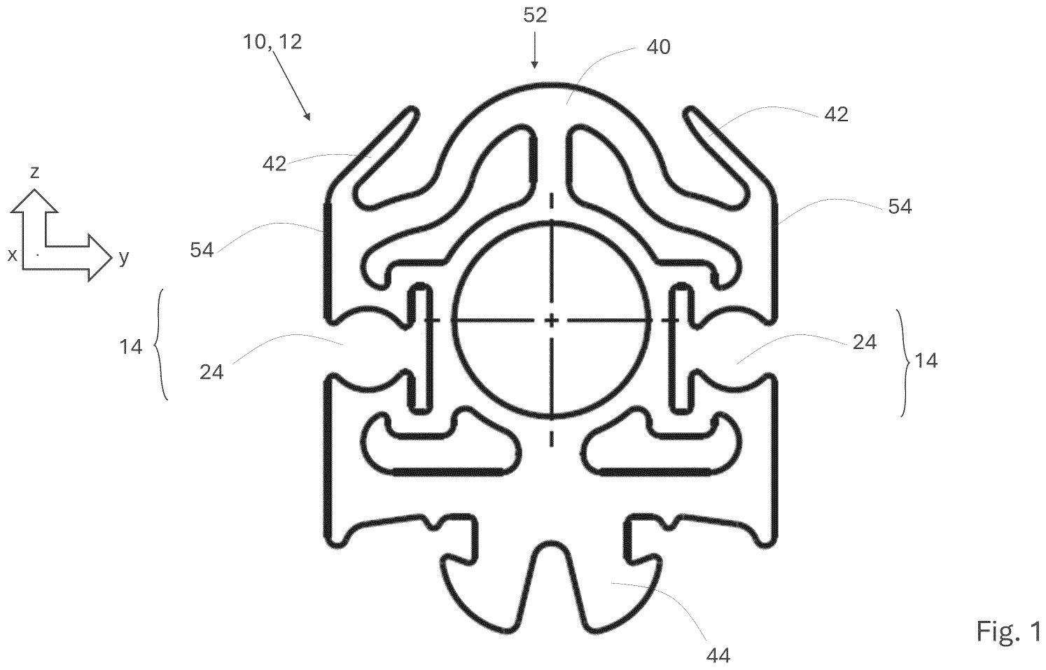

FIG. 1 shows a security profile strip 10 for a door in cross-sectional view transverse to the longitudinal direction x)of the security profile strip 10. The security profile strip 10 has a base body 12, which is the main structure of the security profile strip 10. It contains at least one connecting portion 14, which is used for fastening. The security profile strip 10 has at least one recess 24, the function of which is to accommodate a light-emitting device. Other recesses in FIG. 1 are, for example, hollow spaces without a function that are not used and save material or are reserved for later use. The security profile strip 10 can be fastened in associated recesses and retaining projections of a door profile by a profile foot 44. On the face side 52 opposite the profile foot 44, there is a sealing lip 42 on each side, which protrudes obliquely forward and inward from the outer surface of the profile 54. A movable lip 40 is located centrally between the sealing lips 42, which delimits a space with each sealing lip 42. The movable lip 40 and the sealing lips 42 seal the door against draughts and/or noise and also serve a security function. The security profile strip 10 in FIG. 1 has a recess 24 on each outer surface of the profile 54.

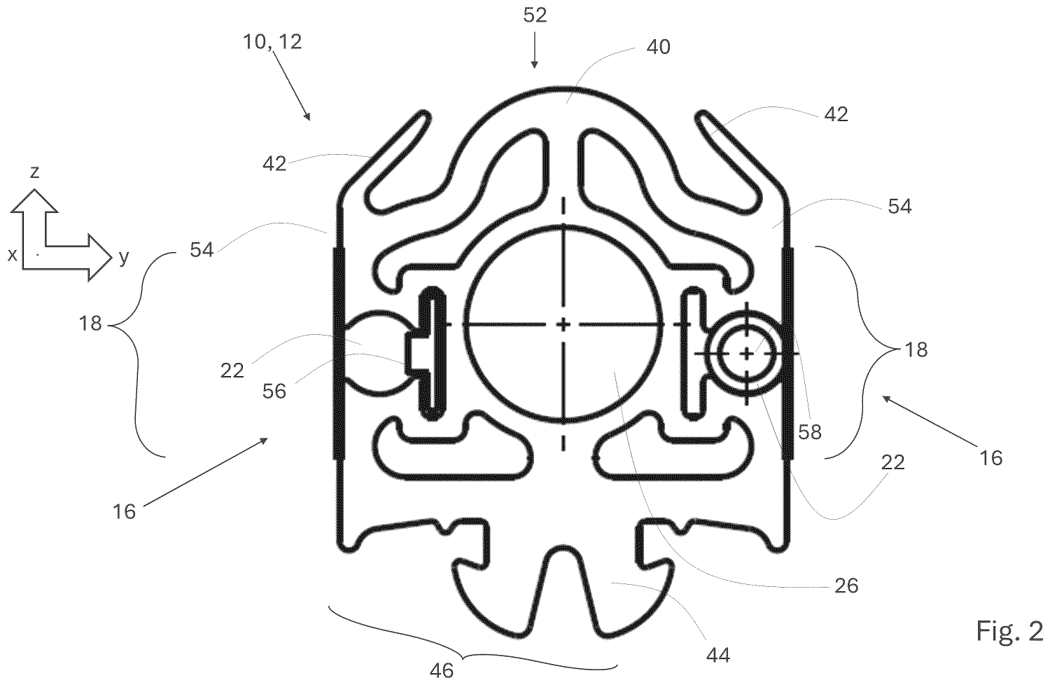

FIG. 2 also shows a security profile strip 10 for a door 50 of a transportation system in a cross-sectional view transverse to the longitudinal direction (x), i.e., in the y-z plane. In the embodiment shown in FIG. 2, a cover 16 with a mating connecting portion 18 was applied to each of the two recesses 24 and fastened with material-bonding properties. The covers 16 with their mating connecting portions 18 cover the recesses 24 in such a manner that first hollow chambers 22 are formed. An anchoring portion 46 is provided for anchoring the security profile strip 10 in a door profile of a door, which engages in the door profile in a material or friction-locked manner. A light-emitting device can emit light through the translucent covers 16 into the outer (left) and inner (right) areas of the transportation system. In this embodiment example, an LED strip 56 can be seen on the left-hand side and a side light guide 58 on the right-hand side, each of which emits light from the first hollow chamber 22 through the cover 16 into an area behind it. A second hollow chamber 26 can be seen in the center of the cross-section, which provides space for a pressure or side light guide sensor system that can ensure the function of the safety opening in the event of a possible entrapment.

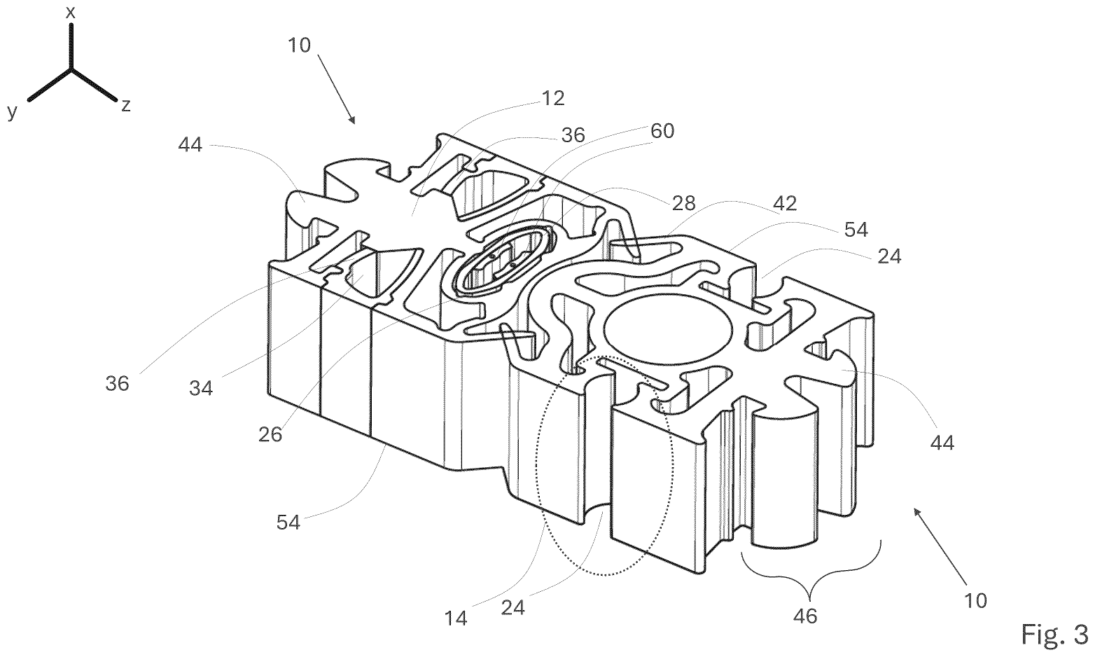

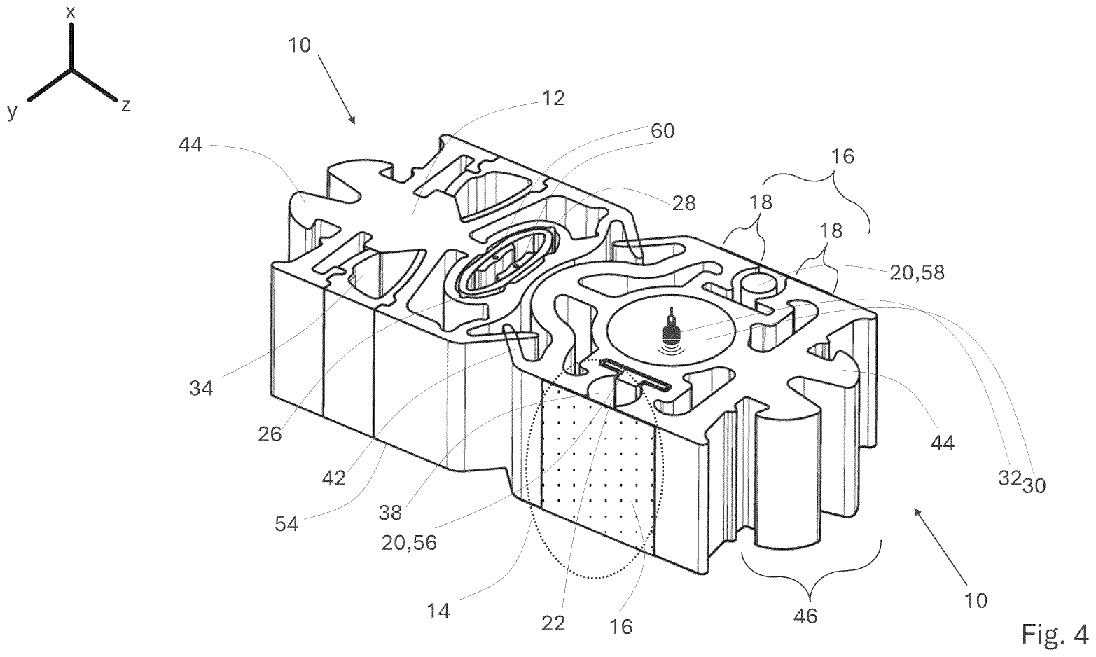

FIGS. 3 and 4 show a more extensive, multifunctional security profile strip 10 which, in addition to the recess 24 for the light-emitting device, provides a second hollow chamber 26 for a pressure detection apparatus an electrical contactor 28. As soon as the security profile strip 10 is touched by a person or an object, potentially indicating entrapment, the security profile strip 10 deforms in the area of the face side 52. This deformation leads, for example, to the electrical contacts 60 of the electrical contactor 28 being brought together, which triggers a switching operation. The triggered switching operation results in a signal that is sent to the control unit of the door to stop the movement immediately and prevent entrapment. In contrast to what is shown here, this function can also be accommodated together in the same hollow chamber as the light-emitting device.

FIG. 3 shows a two-part security profile strip 10 attached to two door leaves with recesses 24 for the light-emitting device and a second hollow chamber 26 for the electrical contactor 28 before the cover is attached to the recess 24. The two security profile strips 10 are joined together in this illustration, so the door is closed. The connecting portion 14 is an area around the recess 24 that is not clearly defined and is shown as a dashed line. In the view of FIG. 4, it has been brought into connection with the mating connecting portion 18 of the cover 16.

FIG. 4 shows a similar two-sided security profile strip construction with an attached cover 16, the mating connecting portion 18 of which is connected to the connecting portion 14 of the base body 10. The mating connecting portion 18 is that part of the cover 16 which is brought into connection with the connecting portion 14 of the base body 12. As shown in FIG. 4, the cover 16 may, for example, include two separate mating connection portions that are interrupted by a portion of the cover 16 that is not connected to the base body 12. The light-emitting devices 20 are arranged as LED strips 56 and side light guides 58 analogous to FIG. 2 in the profile shown on the right on both sides, i.e., emitting light both outwards and inwards. The present disclosure also includes an embodiment variant in which light-emitting devices 20 may also be arranged in the left-hand security profile strip 10, in a hollow space such as the deformation-guiding chamber 34.

In addition to the first hollow chamber 22 and second hollow chamber 26, a third hollow chamber 30 may also be provided, which accommodates an ultrasonic detector or transmitter 32, for example. This is often used instead of or in addition to the electrical contactor 28, so that the ultrasonic detector or transmitter 32 may naturally be arranged in the second hollow chamber 26 instead of the electrical contactor 28.

In addition to the first hollow chamber 22, the second hollow chamber 26, and the third hollow chamber 30 already mentioned, there are usually further hollow spaces in the security profile strip 10, as shown in FIGS. 1-5, the so-called deformation-guiding hollow chambers 34, which are subdivided by webs 36. These deformation-guiding hollow chambers 34 are designed in such a manner that they can deform in the event of an impact or under external pressure. They absorb and distribute the energy of the impact or pressure, reducing the load on the entire structure of the security profile strip 10. This helps to prevent damage to the door and injuries. The webs 36 are the partitions between the first hollow chamber 22, the second hollow chamber 26, the third hollow chamber 30, and the deformation-guiding hollow chambers. They provide the security profile strip 10 with additional stability and strength. By subdividing the first hollow chamber 22, the second hollow chamber 26, the third hollow chamber 30, and the deformation-guiding hollow chambers, the webs 36 ensure that the deformation is controlled and uniform. They prevent the first hollow chamber 22, the second hollow chamber 26, the third hollow chamber 30, and the deformation-guiding hollow chambers from collapsing, which improves the energy absorption and protective function of the security profile strip 10.

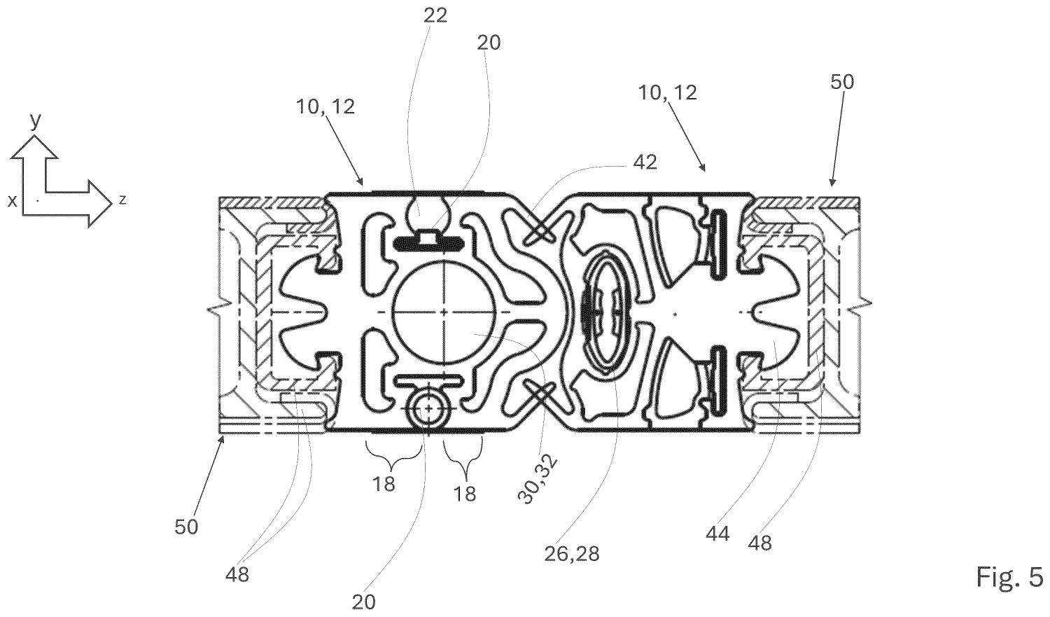

FIG. 5 shows the double security profile strip shown in FIGS. 3 and 4 integrated in an outer door profile 48 in a cross-sectional view transverse to the longitudinal direction. Here, the profile foot 44 of the male anchoring portion 46 engages in a female recess provided for this purpose in the door profile 48 of the door 50. The components described in the previous figures are also recognizable here, such as the first hollow chamber 22 with the light-emitting devices 20 anchored in a door profile 48 on the left-hand side of FIG. 5 and brought into engagement, when the door 50 is closed, with a further security profile strip 10 fastened in a further door profile or, in the case of a U-shaped door profile, the same door profile, on the right-hand side of the figure with a second hollow chamber 26 in which an electrical contactor 28 is inserted. Light is emitted from the area shown on the left in this figure, which may enter the inner area of a transportation system and/or be directed outward, into the outer area of a transportation system. The translucent cover 16, here in the form of a film, provides the necessary protection against vandalism and secures the light-emitting devices 20 inside the profile strip 10.

The present disclosure also includes an embodiment in which a first hollow chamber or two first hollow chambers 22 with light-emitting devices 20 and edge-applied cover 16 is provided in both parts of the security profile strip, left and right.

### LIST OF REFERENCE SIGNS

10 security profile strip
12 base body
14 connecting portion
16 cover
18 mating connecting portion
20 light-emitting devices
22 (first) hollow chamber
24 recess
26 (second) hollow chamber
28 pressure detection apparatus, electrical contactor
30 (third) hollow chamber
32 ultrasonic detector or transmitter
34 deformation-guiding hollow chamber
36 web
38 inner wall
40 movable lip
42 sealing lip
44 profile foot
46 anchoring portion
48 door profile
50 door, door element
52 face side
54 outer surface of the profile
56 LED strips
58 side light guides
60 electrical contacts
x longitudinal direction
y transverse direction/width
z height

1. A security profile strip for a door or a window of a transportation system, a train or bus platform, or for a gate or a barrier, the security profile strip comprising:
a base body, the base body has at least one connecting portion;
at least one light-emitting device;
an at least partially translucent cover which is separate from the base body, the cover includes at least one mating connecting portion,
wherein the connecting portion and the mating connecting portion are connected to one another,
wherein at least one surface of the base body and the cover define a first hollow chamber in which the light-emitting device of the security profile strip is accommodated.

2. The security profile strip according to claim 1, wherein the connection between the connecting portion and the mating connecting portion is materially-bonded and/or form-fitting.

3. The security profile strip according to claim 1, wherein at least one edge-side recess is formed in the base body, in which the at least one light-emitting device is arranged, wherein the connecting portion is provided on both sides and in each case adjacent to the recess, as viewed in a longitudinal direction.

4. The security profile strip according to claim 1, wherein a plurality of edge-side recesses are formed in the base body, which are arranged in particular parallel to and spaced apart from one another in a longitudinal direction of the base body.

5. The security profile strip according to claim 1, wherein the cover and/or the base body is made of an elastic material.

6. The security profile strip according to claim 1, wherein the base body and/or the cover is/are partially made of an opaque material.

7. The security profile strip according to claim 1, wherein the first hollow chamber is bounded in a cross-sectional view transverse to a longitudinal direction around its perimeter by a plurality of translucent and/or opaque portions.

8. The security profile strip according to claim 1, wherein the security profile strip accommodates a pressure detection apparatus and/or an electrical contactor in a second hollow chamber and/or with in the first hollow chamber.

9. The security profile strip according to claim 1, wherein the security profile strip accommodates an ultrasonic transmitter and/or an ultrasonic detector in a third hollow chamber and/or also in the first and/or a second hollow chamber.

10. The security profile strip according to claim 1, wherein the first hollow chamber has a round cross section, an oval cross section, a rectangular cross section, a triangular cross section, a pentagonal cross section, or a hexagonal cross section.

11. The security profile strip according to claim 8, wherein the second hollow chamber has a round cross section, an oval cross section, a rectangular cross section, a triangular cross section, a pentagonal cross section, or a hexagonal cross section.

12. The security profile strip according to claim 9, wherein the third hollow chamber has a round cross section, an oval cross section, a rectangular cross section, a triangular cross section, a pentagonal cross section, or a hexagonal cross section.

13. The security profile strip according to claim 1, wherein the first hollow chamber has an elongated shape, and/or is cylindrical, and/or is filled with air, and/or is coated on one or more of inner walls of the first hollow chamber.

14. The security profile strip according to claim 8, wherein the second hollow chamber has an elongated shape, and/or is cylindrical, and/or is filled with air, and/or is coated on one or more of inner walls of the second hollow chamber.

15. The security profile strip according to claim 9, wherein the third hollow chamber has an elongated shape, and/or is cylindrical, and/or is filled with air, and/or is coated on one or more of inner walls of the third hollow chamber.

16. The security profile strip according to claim 1, wherein the light-emitting device comprises at least one of a light-emitting diode, an organic light-emitting diode, a side light fiber, a light guide, a luminescent, electroluminescent, or a photoluminescent material.

17. A window or door element with a security profile strip according to claim 1, wherein the security profile strip is arranged at a main closing edge and/or at least at one of a secondary closing edges of the door element or the window.

18. A rail or road vehicle, or train or bus platform, with the window or the door element according to claim 17.
